(19) United States
(12) Patent Application Publication
(10) Pub. No.: US 2014/0297269 A1
(43) Pub. Date: Oct. 2, 2014

(54) ASSOCIATING PARTS OF A DOCUMENT BASED ON SEMANTIC SIMILARITY

(71) Applicant: KONINKLIJKE PHILIPS N.V., EINDHOVEN (NL)

(72) Inventors: Yuechen Qian, Briarcliff Manor, NY (US); Merlijn Sevenster, New York, NY (US); Johannes Buurman, 's-Hertogenbosch (NL)

(21) Appl. No.: 14/358,102

(22) PCT Filed: Nov. 12, 2012
(86) PCT No.: PCT/IB2012/056347

§ 371 Date: May 14, 2014

Related U.S. Application Data
(60) Provisional application No. 61/559,189, filed on Nov. 14, 2011.

(51) Int. Cl. G06F 17/27

(52) U.S. Cl. CPC G06F 17/2785
USPC 704/9

(57) ABSTRACT

A system for processing at least one document (7) comprising a text, wherein the system comprises an associating unit (1) arranged for associating a first part of said at least one document with a second part of said at least one document, based on a similarity of semantic data associated with text comprised in the first part and semantic data associated with text comprised in the second part. A semantic data generator (2) is arranged for generating semantic data associated with at least part of the text, wherein the semantic data comprises an explicit representation of semantic information expressed by at least part of the text. A selector (3) is arranged for enabling a user to select the first part of the document.

### FIELD OF THE INVENTION

The invention relates to processing a document comprising a text.

### BACKGROUND OF THE INVENTION

Physicians, for example radiologists and oncologists, routinely review an increasing amount of information to diagnose and treat patients. Patients frequently undergo imaging exams and other exams. As a result, over time, physicians have a large number of studies in their medical records. Each time a physician reads a new exam, he needs to compare the current exam with prior ones in order to determine the progress of previously identified lesions and discover new lesions, if any. When performing this task, he reads, interprets, and correlates findings in both images and reports. This task is both time-consuming and clinically challenging.

A typical radiology report may contain a detailed description of findings, as well as a more concise section containing conclusions. This latter section may be called the impressions section. In a clinical workflow, radiologists tend to read the conclusions section before image interpretation and read the findings section when they need to examine the progression of lesions. When the case is complex, for example, when the patient has multiple lesions and/or multiple imaging modalities were used to examine lesions, the reports typically get longer and often one lesion can be described in multiple parts of the findings section. Still, radiologists need to correlate the information in the impressions section with the information in the findings section, as well the information in the clinical indication section, quickly.

Known viewing systems for radiology reports, such as iSite PACS of Philips Healthcare, Best, The Netherlands, provide keyword-based search to enable a user to look up occurrences of a particular keyword or string in a report.

### SUMMARY OF THE INVENTION

It would be advantageous to have an improved way of processing a document comprising a text. To better address this concern, a first aspect of the invention provides a system comprising an associating unit for associating a first part of said at least one document with a second part of said at least one document, based on a similarity of semantic data associated with text comprised in the first part and semantic data associated with text comprised in the second part.

Using this system, a user can navigate the document more easily, because the portions of the text that have a semantic similarity are associated with each other. This way, the correlations between different portions of the document are clarified.

The system may comprise a semantic data generator for generating semantic data associated with at least part of the text, wherein the semantic data comprises an explicit representation of semantic information expressed by at least part of the text. This is a preprocessing step that helps to find semantically similar parts of the text.

The system may comprise a selector for enabling a user to select the first part of the document. This helps to make the system more efficient, because the associating unit needs only to be applied for the part selected by the user. Moreover, or alternatively, the system may comprise an associated part viewer arranged for indicating to the user a part or parts that are semantically related to the user-selected part.

The system may comprise an output for providing an indication of the association between the first part and the second part of the document to a user. This makes it easy for a user to see the association or associations between the parts.

The associating unit may be arranged for associating the first part of the document with a plurality of second parts of the document, and wherein the output is arranged for providing an indication of the plurality of second parts to the user. This way, reviewing the document is more reliable, because the user is less likely to overlook a situation where more than one part is associated with the first part.

The explicit representation may comprise a representation of a semantic property of a term occurring in said at least part of the text, wherein the semantic data generator is arranged for selecting the semantic property based on an ontology. This representation may be compared with other such representations in respect of other parts of the documents.

The explicit representation may represent a syntactic relation between at least two terms in said at least part of the text. Such a syntactic relation may provide further semantic information that may be compared between parts of the text, to improve the accuracy of the system.

Said at least one document may be or may comprise a document comprising a first section and a second section. The associating unit may be arranged for associating the first part in the first section with the second part in the second section. This is convenient when the different sections relate to the same semantic object.

The system may comprise a terms unit for providing access to a collection of terms relevant for a knowledge domain, and wherein the semantic data generator is arranged for generating semantic data relating to terms from the collection that appear in the text, and wherein the associating unit is arranged for giving more weight to terms from the collection than to other terms in the assessing of the similarity. This allows the system to be specifically optimized for a knowledge domain.

The system may comprise a statistics unit for providing access to statistical occurrence information relating to terms in a knowledge domain. The semantic data generator may be arranged for matching the terms in the first part of said at least one document and/or the second part of said at least one document with the terms in the knowledge domain. Moreover, the semantic data generator may be arranged for taking into account the statistical occurrence information of the matching terms in the process of generating the semantic data. This provides an efficient manner of generating semantic information, because statistical occurrence, including co-occurrence, of terms may provide useful clues to semantic similarity of text portions, and statistical information can be obtained in an efficient manner.

The statistical occurrence information may comprise a frequency of occurrence of individual terms. The associating unit may be arranged for giving more weight to infrequent terms than to frequent terms in the assessing of the similarity. This is based on the idea that, when an infrequently occurring term is used in two different portions of the text, it is relatively likely that these text portions are semantically related to each other.

The first part may relate to a conclusion and the second part may relate to a finding or a clinical indication. The associating unit may be arranged for evaluating a compatibility of the finding or the clinical indication with the conclusion in the assessing of the similarity. This allows to further compare the semantic correspondence, because incompatible sentences may be unrelated to each other. Alternatively, this aspect may be used to find inconsistencies in the text.

In another aspect, the invention provides a workstation comprising a system as set forth. This provides useful hardware that can be used for implementing the system.

In another aspect, the invention provides a method of processing at least one document comprising a text, wherein the method comprises associating a first part of said at least one document with a second part of said at least one document, based on a similarity of semantic data associated with text comprised in the first part and semantic data associated with text comprised in the second part.

In another aspect, the invention provides a computer program product comprising instructions for causing a processor system to perform a method as set forth herein.

It will be appreciated by those skilled in the art that two or more of the above-mentioned embodiments, implementations, and/or aspects of the invention may be combined in any way deemed useful.

Modifications and variations of the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings, similar items are denoted by the same reference numeral.

FIG. 1 is a block diagram of a system for processing at least one document comprising a text.

FIG. 2 is a flowchart of a method of processing at least one document comprising a text.

FIG. 3 is a sketch of an example report comprising a plurality of sections.

FIG. 4 is a sketch of an example report in which associated sentences are highlighted.

### DETAILED DESCRIPTION OF EMBODIMENTS

Physicians (e.g. radiologists and oncologists) have to deal with increasing amounts of information to diagnose and treat patients. Patients, e.g. with cancers, frequently undergo imaging and other exams; as a result, over time, physicians have tens of studies in their medical records. Each time physicians read a new exam, they need to compare the current exam with prior ones in order to determine the progress of previously identified lesions and discover new lesions, if any. This task requires them to read, interpret, and correlate findings in both images and reports, which is both time-consuming from a workflow point of view and clinically challenging.

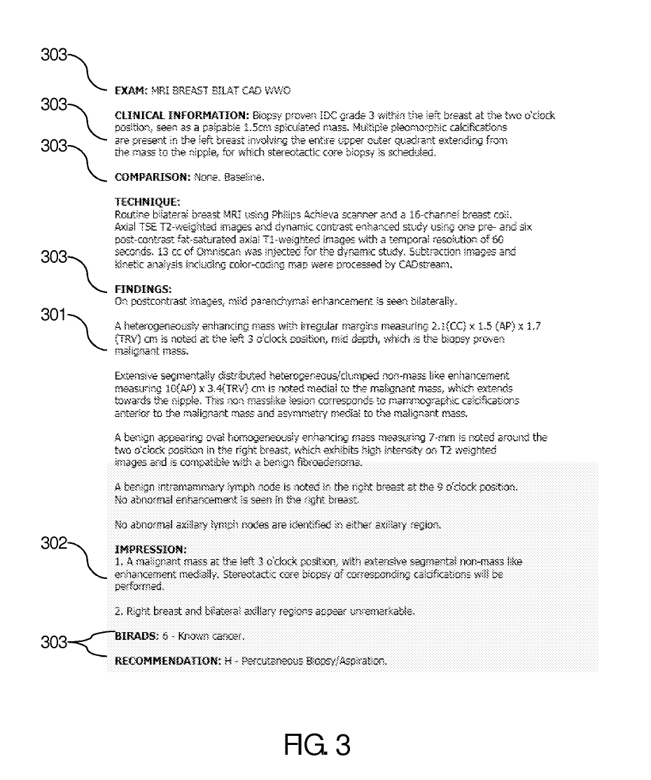

FIG. 3 illustrates a layout of a typical radiology report. Such a radiology report contains, among others, a detailed description of lesions in a Findings section 301 and concise conclusions in an Impression section 302, as illustrated in FIG. 3. The radiology report can contain further sections 303.

In a clinical workflow, radiologists tend to read the Impression section before image interpretation and read the Findings section when they need to examine the progression of lesions. When the patient has multiple complicated lesions, the report becomes lengthy, which is typically the case for patients with cancers. Radiologists need to correlate the information in the Impression section with that in the Findings section quickly.

For example, suppose a radiologist finds a lesion in the left breast of a patient and would like to know the measurement in the last workout. He searches for “mass” in the above-mentioned report. He may find many occurrences of “mass”, including ones that refer to a mass in the right breast, as shown in the example report shown in FIG. 3. It would be useful if the system could show an indication of particularly those occurrences of “mass” that relate to the left breast. The radiology may also search for “left mass” or “mass left”, however this may not yield the desired result.

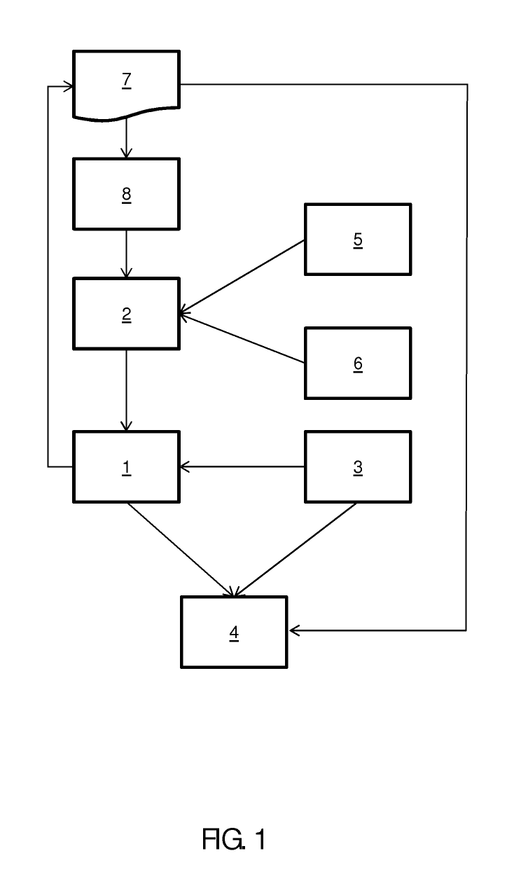

FIG. 1 illustrates aspects of a system for processing at least one document 7 comprising a text. The system may be implemented, for example, at least partly by means of software. The software may be executed on a workstation and/or by means of a distributed computer system. The workstation may be used to control the features of the system, using interaction peripherals such as keyboard, mouse, touch sensitive display. The system may receive documents and store any results (such as associations between portions of documents) from local or remote storage media. For example, a communications port may be provided for communicating to a remote storage server via a network connection.

The system may comprise an associating unit 1 for associating a first part of said at least one document with a second part of said at least one document, based on a similarity of semantic data associated with text comprised in the first part and semantic data associated with text comprised in the second part. Such similarity may be detected using, for example, a query formation engine and a query matching engine, examples of which are described elsewhere in this description.

The system may comprise a semantic data generator 2 for generating semantic data associated with at least part of the text. The semantic data may comprise an explicit representation of semantic information expressed by at least part of the text. Such explicit representation may refer to terms in an ontology, for example. For example, the semantic information may represent syntactic relations between the terms used in the text. More details are provided elsewhere in this description.

The system may comprise a selector 3 for enabling a user to select the first part of the document. For example, the user may be enabled to indicate the part by pointing to it or by selecting it using a mouse pointer.

The system may comprise an output 4 for providing an indication of the association between the first part and the second part of the document to a user. The output 4 may comprise a software module arranged for controlling a graphical output device, in order to display the indication of the association on a display device.

The associating unit 1 may be arranged for associating the first part of the document with a plurality of second parts of the document. The output 4 may be arranged for indicating the plurality of second parts to the user. For example, the plurality of second parts are highlighted. It is also possible to indicate the presence of such second parts in portions of the document that are not currently visible on the screen, for example by providing symbols on the appropriate positions of a scrollbar that controls which portion of the document is displayed.

The explicit representation may comprise a representation of a semantic property of a term occurring in said at least part of the text. The semantic data generator 2 may be arranged for selecting the semantic property based on an ontology. The semantic property may be looked up in the ontology based on the term appearing in the text. Moreover, based on syntactic relationships of the terms within the text, more detailed semantic properties may be extracted.

The system may be arranged for operating on a single document that comprises a plurality of sections. When the user indicates a part in a first section, the associating unit 1 may be arranged for finding a semantically related portion of text in a different second section of the same document. Alternatively, the associating unit may be arranged for finding the semantically related portion of the text in a different document.

The system may comprise a terms unit 5 for providing access to a collection of terms that are relevant to a particular knowledge domain, such as a particular medical profession. The semantic data generator 2 may be arranged for generating semantic data relating to terms from the relevant collection that appear in the text. The associating unit 1 may be arranged for giving more weight to terms from the collection than to other terms in the assessing of the similarity.

The system may comprise a statistics unit 6 for providing access to statistical occurrence information relating to terms in a knowledge domain. Such a knowledge domain may comprise terms relating to a field of use, such as radiology. The statistics unit 6 may be operatively coupled to the associating unit 1, for example via the semantic data generator 2, as shown in FIG. 1. The semantic data generator 2 may be arranged to generate the semantic data also based on the statistical occurrence information provided by the statistics unit 6. The statistical occurrence information may comprise many kinds of statistical information relating to the terms in the knowledge domain. For example, the co-occurrence frequencies of pairs of terms may be taken into account. Other kinds of statistical information and the way in which it may be applied are described elsewhere in this description. The semantic data generator 2 may be arranged for matching the terms in the document with the terms in the knowledge domain, and for using the statistical occurrence information of matching terms in the assessing of the semantic similarity between different parts of the document.

For example, the statistical occurrence information may comprise information relating to a frequency of occurrence of individual terms. This information may be included in the semantic data for a part of a document. The associating unit 1 may be arranged for giving more weight to infrequent terms than to frequent terms in the assessing of the similarity.

The first part of the text may relate to a conclusion and the second part may relate to a finding or a clinical indication. The user may thus indicate a sentence or other portion of the conclusion, to request the corresponding portions in the findings and/or clinical indication sections. Moreover, the associating unit 1 may be arranged for evaluating a compatibility of the finding or the clinical indication with the conclusion in the assessing of the similarity. This may be determined using statistical or logical deductions, as described elsewhere in this description.

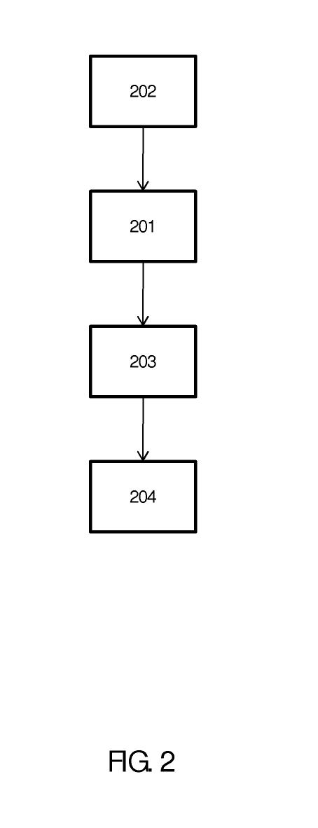

FIG. 2 illustrates an example of a method of processing at least one document comprising a text. The method comprises the step 201 of associating a first part of said at least one document with a second part of said at least one document, based on a similarity of semantic data associated with text comprised in the first part and semantic data associated with text comprised in the second part. Step 201 may be repeated for different parts of text. Step 201 may be preceded by an initialization step 202 in which semantic data associated with different parts of the text is generated, wherein the semantic data comprises an explicit representation of semantic information expressed by at least part of the text. This explicit representation may be used in step 201 to determine one or more portions of text to be associated with one another. After step 201, in step 203, a user may be enabled to indicate a particular phrase or sentence or group of sentences that the user is interested in. This may be done by touching the relevant text, using a touch sensitive display or by using a mouse pointing device. In step 204, the system looks up and displays the corresponding associated portion or portions of text. For example, these portions are displayed in a list format, or they are indicated in the context of the surrounding text of the document. Steps 203 and 204 may be repeated until a termination signal is received, after which the method terminates. In an alternative method, step 203 may be skipped. Instead, automatic display modes may be provided in step 204, such as color coding of any associated portions of text, by displaying associated portions in the same color and unassociated portions in a different color. Other interaction possibilities are within reach of the person skilled in the art in view of the present description. The method may be implemented by means of a computer program which may be stored on a storage medium or transmitted via a transmission medium.

Returning to FIG. 1, the system may comprise a report structure analysis module 8 arranged for detecting structural features of the document 7, such as sentences, paragraphs, and sections. Such analysis may also be performed as a preprocessing step to enable analyzing the different sentences as separate parts of the document 7 by the semantic data generator 2 and/or the associating unit 1. Moreover, the associating unit 1 may be arranged for only associating two of the parts of the same document if they are located in different sections of the document.

The semantic data generator 2 may comprise an extraction module that extracts keywords from sentences. Such an extraction module may extract keywords that are within a particular knowledge domain, such as a medical knowledge domain, according to information provided by the terms unit 5.

The associating unit 1 may be arranged for evaluating how much two given sentences are related, based on the semantic data.

A user interface including a selector 3 and an output 4 may be provided. The interface may be arranged for enabling the user to select a sentence and render any related sentences found. In such a user interface, the radiologist may be enabled to move the cursor of a computer mouse over the content of a radiology report on a workstation. When the cursor is positioned over a sentence in the Impression section, the system automatically finds and highlights sentences in the Findings that are related to the sentence in the Impression section. Additionally, the system indicates the location of further related sentences in the document by means of indications in the scrollbar of a textbox in which the report is displayed, for easy navigation.

The disclosed system can be implemented in various manners, including the following one.
1. The system may receive a document 7, such as a textual report, as input. The report structure analysis module may detect sentences, paragraphs, and sections in the document.

This can be done in various manners, including natural language processing and computer linguistics. In the latter case, section headers can be defined in a lookup table and the occurrence of section headers can be detected using keyword-based search algorithms.

Paragraph boundaries can also be detected using regular expressions; paragraph boundaries are typically combinations of carriage return, newline characters, and white spaces.

Sentence boundaries are usually marked by means of a period character. Rules can be included to avoid treating a period appearing in a numeric value (“3.5 cm”) as a sentence boundary.
2. The semantic data generator 2 may comprise an extraction module that extracts (e.g. medical) keywords from sentences. There are several ways to extract such information:

Natural language systems like MEDLEE can be used to extract medical findings. For example, the occurrence of “mass” can be detected and classified as a “Finding” in SNOMED, and “1.3 cm” can be detected and classified as a “Measurement”. To use this approach, domain-specific ontologies may be incorporated to process specific types of reports.

Computer linguistics systems can also be used to extract keywords from systems. Sentences can be tokenized into a sequence of words. Then, frequently-encountered English words like “the”, “and” can be discarded.
3. The associating unit 1 may be arranged for evaluating how much two given parts, such as sentences, are related. Depending, among others, on the type of information extracted by the semantic data generator, different matching algorithms can be used.

If findings are extracted, each sentence may be presented in the system as semantic structures. Semantic structures can take many shapes. A relatively simple one comprises a list of keywords with semantic type. A more sophisticated structure comprises a list of findings, wherein a finding is a radiological object (radiologic findings like masses, procedures like ultrasound, etc) with modifiers (anatomies like “breast”, locations like “2 o'clock”, likelihood like “positive”). The closeness between two sentences can be evaluated based on underlying semantic structures. The more structures two sentences have in common, the closer they may be in terms of their content. The system may also optimize the weighting of information in semantic structures. For example, finding type, anatomy and locations may be weighted heavier than likelihood.

If keywords are extracted, the system may create the stem of detected keywords. In other words, each sentence may be presented as a list of stems of keywords. Given any two sentences, the system may evaluate how close they are: the more stems two sentences have in common, the more likely it is that they are related. The system may compute the closeness between a selected sentence from the Impression section and every sentence from the Finding sections.

Not every sentence contains a complete description of a lesion. Often one lesion is described in multiple consecutive sentences in a paragraph. The running average algorithms can be applied here to balance the closeness of sentences from one paragraph in the Finding section and the selected paragraph in the Impression section.
4. The output 4 may provide an indication, for example by highlighting the background, of the matching sentences.

The matching algorithm may provide the closeness score of a found sentence. That score can be used to adjust the background of the matching sentences: the higher the score is, the more visible the background may be rendered.
5. In an embodiment, Optical Character Recognition can be used as follows:

A paper report is scanned in. Some systems store scanned reports in the PACS.

Optical Character Recognition (OCR) is applied to the text, leading to a text document.

The system may comprise a query formation engine that transforms a piece of text selected from a first part of a document into a semantic data structure, based on the selected text and the domain knowledge including a relevant ontology.

The semantic data generator 2 may comprise a query formation engine that converts a part of the document into a query. The associating unit 1 may comprise a query matching engine for matching the semantic data relating to other parts of the same or another document with the query.

The query formation engine may be arranged for converting a piece of text into a query in one of many ways, such as:

Based on n-grams (i.e. n consecutive words in the sentence)

Based on noun phrase chunks (which can be detected by chunking algorithms)

Based on ontological concepts (which can be extracted by concept anchoring algorithms). In this case, a query can be a list of SNOMED concepts.

Based on another semantic data structure. The semantic data structure may comprise three aspects of information contained in the selected piece of text: 1) medical terms and mapped ontological concepts 2) syntactic relation of extracted medical terms 3) domain knowledge of the concepts.

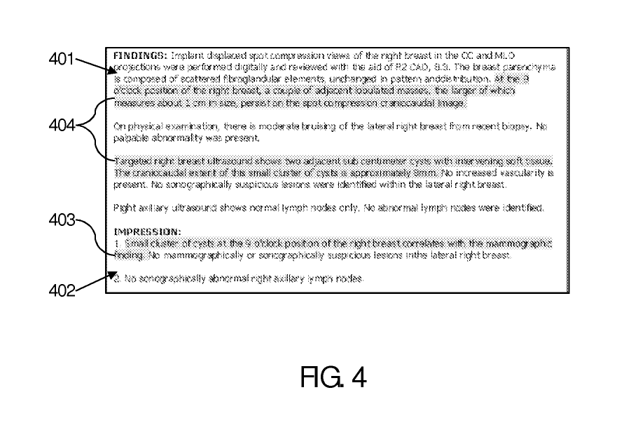

FIG. 4 illustrates a report as may be displayed by the output 4. The report comprises a findings section 401 and an impression section 402. When the first sentence 403 of the Impression section is in focus, the system highlights other sentences 404 in the Findings section that relate to the sentence 403 in focus.

The semantic data structure of a sentence may be analyzed, as explained hereinafter with reference to the following exemplary sentence “Small cluster of cysts at the 9 o'clock position of the right breast correlates with the mammographic finding”:

Medical terms can be extracted from the text, using existing natural language processing (NLP) algorithms like MEDLEE and MetaMap. Medical ontologies (BIRADS, SNOMED-CT, RadLex, etc.) or combinations thereof can be used, depending on the nature of the report under investigation. For example, a term “cysts” may be detected in the text and mapped to a semantic type “finding”. Similarly, “9 o'clock” may be mapped to semantic type “location”. Moreover, the likelihood of such a concept may be determined, e.g. using NegEx.

Syntactic relations of extracted terms may be added to extracted terms. Syntactic relations can take many forms. The Stanford Parser can be used to detect the grammatical structure of sentences. ANTLE can be used to build abstract syntax trees. Alternatively, the system can use distances (number of words) to describe the closeness of two consecutive terms, as illustrated in the diagram above.

For extracted terms, domain knowledge may be added to them. For example, the word “cyst” is most often used in ultrasound imaging reports while mammographic findings typically are masses and calcifications. Such information can be added to the representation of semantic information.

The query matching engine of the associating unit 1 may be arranged for matching a created query based on a first part of the text with a text from a second part of the same or another document, the second part of the document being disjoint from the first part. Techniques to implement the matching include support vector machine algorithms. Other possible techniques include:

A metric based on matching query elements can be refined using background knowledge on the frequency of occurrence. This way it is possible to degrade the weight of common words (“the”) and upgrade the weight of uncommon terms (“carcinoma”).

A statistical model can be used to model non-semantic dependencies between words. For instance, if a cluster of microcalcifications is reported in the findings, this may trigger a biopsy recommendation in the conclusion. There may be no direct semantic relation between microcalcification and biopsy. However, a probabilistic model can be used to detect that the two are correlated nonetheless.

A statistical model can be used to model if a sentence reports a benign or a malignant finding. This is based on the idea that a benign finding sentence should not be linked to a malignant conclusion sentence and vice versa. However, this is not a limitation.

A statistical/rule-based model can be used to detect the body location the sentence pertains to. If the finding sentence refers to the left arm pit and the conclusion sentence pertains to the right breast, it is unlikely that they should be linked.

A rule-based model can be used to detect if one of the sentences contains a negation.

A statistical model can be used to detect the “temporal orientation” of a sentence, that is, if it describes a past procedure, the present study, or a future procedure (mostly in the form of a recommendation).

The position of the sentences in the report/section/paragraph can also be taken into account.

With semantic data structures, the matching algorithm may weight the similarity of the semantic data structure of two sentences in a selection of aspects.

Whether both have the same modality.

Whether both have the same laterality and anatomy.

Whether both have the same or similar likelihood.

Whether the finding type is the same or one is an instance of another.

Whether the location of the finding is the same or in the vicinity.

Consider the following example sentences. A: “Small cluster of cysts at the 9 o'clock position of the right breast correlates with the mammographic finding”. B: “Targeted right breast ultrasound shows two adjacent sub centimeter cysts with intervening soft tissue.” C: “No sonographically suspicious lesions were identified within the lateral right breast”. The selection and weights of aspects may be domain specific. For example, sentence B may be considered to be relevant to A, because both describe a cyst in the right breast. Sentence C may partially match A—both contain concepts related to ultrasound findings in the right breast. However, sentence C may be considered to be not relevant because the likelihood of findings in C) is negative.

The query matching engine may incorporate also a search space selection component. The system may be capable of matching the query with a text from a second part of the same document, e.g. different sections, that is disjoint from the first part. The system can also match text from a part in another document. The selection of search space can be done manually or automatically using presets. The selection of search space can also be done using the context (including the section of the report and finding type). For example, when the selected sentence in the Impression section contains “biopsy”, the system finds the biopsy results of the selected finding.

The above disclosed techniques can be implemented in many ways.

When a radiologist reads a finding in the impression section of a radiology report, the system may automatically find and highlight the relevant detailed description of the finding in the Findings section or in the Clinical Indication section.

When a radiologist reads reasons of exam in the Clinical Indication section of a radiology report, the system may automatically find and highlight the relevant detailed description in the patient's EPR (Electronic Patient Record).

When a radiologist reads a finding in a radiology report, the system may automatically find and highlight in the work-list which of the prior radiology reports of the same patient contain a relevant description of the selected finding and, furthermore, the system may highlight the found relevant description of the selected finding in those prior reports.

When a radiologist reads a finding in a radiology report, the system may automatically find and highlight in a pathology report the biopsy results of the selected finding.

Other ways of indicating the associated portions, using color coding or arrows, for example, may be used instead of or in addition to highlighting.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for processing at least one document comprising a text, wherein the system comprises an associating unit for associating a first part of said at least one document with a second part of said at least one document, based on a similarity of semantic data associated with text comprised in the first part and semantic data associated with text comprised in the second part.

2. The system according to claim 1, further comprising a semantic data generator for generating semantic data associated with at least part of the text, wherein the semantic data comprises an explicit representation of semantic information expressed by at least part of the text.

3. The system according to claim 1, comprising a selector for enabling a user to select the first part of the document.

4. The system according to claim 1, comprising an output for providing an indication of the association between the first part and second part of the document to a user.

5. The system according to claim 3, wherein the associating unit is arranged for associating the first part of the document with a plurality of second parts of the document, and wherein the output is arranged for providing an indication of the plurality of second parts to the user.

6. The system according to claim 2, wherein the explicit representation comprises a representation of a semantic property of a term occurring in said at least part of the text, wherein the semantic data generator is arranged for selecting the semantic property based on an ontology.

7. The system according to claim 2, wherein the explicit representation represents a syntactic relation between at least two terms in said at least part of the text.

8. The system according to claim 1, wherein said at least one document is a document comprising a first section and a second section, and wherein the associating unit is arranged for associating the first part in the first section with the second part in the second section.

9. The system according to claim 2, further comprising a terms unit for providing access to a collection of terms relevant for a knowledge domain, and wherein the semantic data generator is arranged for generating semantic data relating to terms from the collection that appear in the text, and wherein the associating unit is arranged for giving more weight to terms from the collection than to other terms in the assessing of the similarity.

10. The system according to claim 1,
further comprising a statistics unit for providing access to statistical occurrence information relating to terms in a knowledge domain, and
wherein the semantic data generator is arranged for matching the terms in the first part of said at least one document and/or the second part of said at least one document with the terms in the knowledge domain, and taking into account the statistical occurrence information of the matching terms in the process of generating the semantic data.

11. The system according to claim 10, wherein the statistical occurrence information comprises a frequency of occurrence of individual terms, and wherein the associating unit is arranged for giving more weight to infrequent terms than to frequent terms in the assessing of the similarity.

12. The system according to claim 1, wherein the first part relates to a conclusion and the second part relates to a finding or a clinical indication, and wherein the associating unit is arranged for evaluating a compatibility of the finding or the clinical indication with the conclusion in the assessing of the similarity.

13. A workstation comprising a system according to claim 1.

14. A method of processing at least one document comprising a text, wherein the method comprises associating a first part of said at least one document with a second part of said at least one document, based on a similarity of semantic data associated with text comprised in the first part and semantic data associated with text comprised in the second part.

15. A computer program product comprising instructions for causing a processor system to perform the method according to claim 14.
